(19) United States
(12) Patent Application Publication
(10) Pub. No.: US 2026/0118866 A1
(43) Pub. Date: Apr. 30, 2026

(54) Techniques for Natural Language Explanation of Fault Diagnoses in Complex Systems

(71) Applicant: UCHAGO ARGONNE, LLC, Chicago, IL (US)

(72) Inventors: Akshay J. DAVE, Naperville, IL (US); Tat Nghia Nguyen, Naperville, IL (US); Richard B. VILIM, Sugar Grove, IL (US)

(21) Appl. No.: 19/089,088

(22) Filed: Mar. 25, 2025

Related U.S. Application Data
(60) Provisional application No. 63/633,177, filed on Apr. 12, 2024.

(51) Int. Cl. G05B 23/02; G06F 16/332

(52) U.S. Cl. CPC G05B 23/0267; G06F 16/332

(57) ABSTRACT

Techniques enabling natural language explanations of fault diagnoses are disclosed herein. An example method includes receiving requests associated with a fault within a process system and applying a large language model (LLM) to the requests. Applying the LLM includes querying a symbolic engine based on the requests. The symbolic engine constrains responses output by the LLM based on a system graph associated with the process system. Applying the LLM also includes receiving, from the symbolic engine, an inferential sequence corresponding to the fault that is represented within the system graph and determining a response to at least one of the requests based on the inferential sequence. The example method further includes storing one or more data objects indicating each of the responses. These disclosed techniques improve over conventional techniques by integrating LLMs into the fault diagnostics process and simultaneously reducing/eliminating model hallucinations to increase the accuracy of all LLM outputs.

### CROSS-REFERENCE TO RELATED APPLICATION

This application claims priority to U.S. Provisional Patent Application No. 63/633, 177, entitled “Techniques for Natural Language Explanation of Fault Diagnoses in Complex Systems” filed Apr. 12, 2024, the disclosure of which is incorporated herein by reference in its entirety.

### STATEMENT REGARDING FEDERALLY SPONSORED RESEARCH OR DEVELOPMENT

This invention was made with government support under Contract No. DE-AC02-06CH11357 awarded by the United States Department of Energy to UChicago Argonne, LLC, operator of Argonne National Laboratory. The government has certain rights in the invention.

### TECHNICAL FIELD

The present disclosure generally relates to fault diagnostics, and more particularly, to the use of large language models (LLMs) to provide natural language explanations of fault diagnoses in complex systems.

### BACKGROUND

The operation of complex systems (e.g., process systems) necessitates robust diagnostic capabilities, particularly as part of a broader autonomous operation framework. The need for diagnostics is driven by, among other considerations, enhancing system operators'response times/capabilities to identified faults. For example, in systems such as nuclear power plants, the ability of operators to understand and trust the provided diagnostic information is of paramount importance. It is insufficient to be informed that a fault has occurred. Instead, it is crucial to quickly understand why and how the fault occurred to make the most effective corrective actions in a timely manner.

To facilitate such effective, timely corrective actions, diagnostics tools strive to provide information with a high degree of explainability for the operator. Explainability refers to a diagnostics tool's capability to provide interpretable answers grounded in physical models/data in response to arbitrary questions from an operator. However, conventional techniques/tools notably lack such explainability, as conventional techniques/tools cannot interpret arbitrary questions and/or provide readily interpretable answers. As a result, these conventional techniques/tools prolong the fault diagnostics process, delay operators performing corrective actions to resolve faults, and increase system downtime.

Therefore, in general, fault diagnostics systems are an area of great interest, and conventional techniques are insufficient for providing explainable, accurate, and timely responses to arbitrary operator questions. Accordingly, a need exists for techniques that provide operators with such explainable, accurate, and timely responses.

### SUMMARY OF THE DISCLOSURE

In some aspects, a method for improving fault diagnostics includes receiving, at one or more processors, one or more requests associated with a fault within a process system. The method further includes applying, by the one or more processors, a large language model (LLM) to the one or more requests. Applying the LLM includes querying a symbolic engine based on the one or more requests, wherein the symbolic engine constrains responses output by the LLM based on a system graph associated with the process system. The method further includes receiving, from the symbolic engine, an inferential sequence corresponding to the fault that is represented within the system graph and determining a response to at least one of the one or more requests based on the inferential sequence. The method further includes storing, by the one or more processors, one or more data objects indicating each of the responses.

In some aspects, a computer system for improving fault diagnostics includes one or more processors and a non-transitory computer-readable medium storing thereon instructions. When the instructions are executed by the one or more processors, the instructions cause the computer system to: receive one or more requests associated with a fault within a process system, apply a large language model (LLM) to the one or more requests, wherein applying the LLM includes querying a symbolic engine based on the one or more requests, wherein the symbolic engine constrains responses output by the LLM based on a system graph associated with the process system, receiving, from the symbolic engine, an inferential sequence corresponding to the fault that is represented within the system graph, and determining a response to at least one of the one or more requests based on the inferential sequence, and store one or more data objects indicating each of the responses.

In some aspects, a non-transitory computer-readable storage medium includes instructions that, when executed by one or more processors, cause the one or more processors to: receive one or more requests associated with a fault within a process system; apply a large language model (LLM) to the one or more requests, wherein applying the LLM includes querying a symbolic engine based on the one or more requests, wherein the symbolic engine constrains responses output by the LLM based on a system graph associated with the process system, receiving, from the symbolic engine, an inferential sequence corresponding to the fault that is represented within the system graph, and determining a response to at least one of the one or more requests based on the inferential sequence; and store one or more data objects indicating each of the responses.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 is a block diagram of a system for improving fault diagnostics of a process system.

FIG. 2 is a block data flow diagram including certain components from the system of FIG. 1, in accordance with various embodiments described herein.

FIG. 3 is an example dependency structure of an example model residual, in accordance with various embodiments described herein.

FIG. 4A depicts two example diagnostic sequences performed by a diagnostics tool, in accordance with various embodiments described herein.

FIG. 4B depicts two example reversed diagnostic sequences represented within a system graph, in accordance with various embodiments described herein.

FIG. 4C is a block data flow diagram representing an improved fault diagnostics process, in accordance with various embodiments described herein.

FIG. 5 depicts a flow diagram representing an example computer-implemented method, in accordance with various embodiments described herein.

FIGS. 6A-6D depict example input-output sequences of an operator submitting requests to the diagnostics agent, in accordance with various embodiments described herein.

### DETAILED DESCRIPTION

Broadly speaking, the techniques of the present disclosure relate to natural language fault diagnostics and explanations using an LLM and a symbolic engine. Processors of the systems described herein generally receive one or more requests associated with a fault within a process system (e.g., nuclear power plant, fuel reprocessing plants, biomedical systems, pharmaceutical systems), and apply the LLM to the one or more requests. The LLM queries the symbolic engine based on the requests, and the symbolic engine constrains responses outputs by the LLM based on a system graph associated with the process system. The symbolic engine determines an inferential sequence corresponding to the fault and returns the sequence to the LLM, which determines a response to the request(s) based on the inferential sequence. The processors of the systems described herein then generate one or more data objects indicating each of the responses.

As mentioned, conventional fault diagnostics tools generally suffer from an inability to provide explainable outputs to arbitrary (e.g., arbitrarily phrased) operator queries. LLMs present an opportunity to resolve these issues of conventional techniques, as such models possess powerful natural language understanding capabilities to provide explainable outputs in response to arbitrary interactions with individuals. However, despite these capabilities, LLMs are susceptible to “hallucinations” where the models erroneously present inaccurate data/information in responses as fact. Hallucinations in the context of fault diagnostics could lead to erroneous inferences regarding a fault source, potential consequences of the fault, and/or numerous other inaccurate statements that could mislead operators and thereby negate the advantages of implementing the LLM. Thus, any system implementing an LLM to overcome the challenges faced by conventional systems requires constraints on the LLM suitable to reduce or eliminate hallucinations.

To overcome the issues faced by conventional systems and eliminate/reduce hallucinations, the present techniques implement an LLM to determine responses to operator requests/queries while reducing response hallucinations by leveraging a symbolic engine and system graph. The present techniques reduce/eliminate hallucinations of an LLM by the symbolic engine constraining the LLM responses based on the system graph associated with a process system. Briefly, the system graph represents physics-based knowledge of the process system that can serve as the basis for explaining fault diagnoses. The system graph generally indicates system data corresponding to processes of the process system, such that the system graph prohibits the LLM from including information/data in a response that is not included or clearly indicated in the system data. Accordingly, the symbolic engine and system graph reduce/eliminate hallucinations and correspondingly increase the accuracy of all LLM outputs.

The system data indicated by the system graph corresponds to sensor data, component data, fault data, residual data, and/or other data of the processes of the process system. As an example, the system data indicated by an inferential sequence of the system graph may be a set of sensor data measured by sensors associated with a component in which a fault was detected. The set of sensor data is actual, measured data from sensors of the process system and can therefore function as ground truth data for responding to factual queries about the fault. Thus, constraining responses output by the LLM based on the system graph reduces/eliminates hallucinations at least because the system graph indicates such system data of the process system. The resulting data objects indicating these responses that are stored by the systems described herein also have correspondingly fewer inaccuracies because each response has a significantly lower likelihood of including hallucinated and/or otherwise erroneous data.

The techniques of the present disclosure also improve the functionality of a computing device (e.g., a hosting server such as a central server) at least by using an LLM in a particular way to enhance the intelligence or predictive ability of the computing device. This LLM, executing on the computing device, can more accurately respond to arbitrary requests/queries than was possible using conventional techniques. That is, the present disclosure describes improvements in the functioning of the computer itself because the computing device can more accurately determine responses to arbitrary input requests/queries. This improves over the prior art at least because existing systems completely lack such arbitrary input response capabilities. Additionally, the techniques of the present disclosure improve over conventional techniques by constraining responses output by the LLM to reduce/eliminate hallucinations, thereby further improving the accuracy of the arbitrary input response capabilities that conventional techniques lack.

Moreover, the present disclosure includes effecting a transformation or reduction of a particular article to a different state or thing, e.g., reducing/eliminating the inaccuracies of a computing system (and associated subsystems/components/devices) from a non-optimal or error state (e.g., prone to hallucinations) to an optimal (or closer to optimal) state by constraining the LLM responses to a request/query using a symbolic engine and a system graph that is associated with data of a process system related to the request/query.

Still further, the present disclosure includes specific features other than what is well-understood, routine, conventional activity in the field, or adding unconventional steps that demonstrate, in various embodiments, particular useful applications, e.g., querying a symbolic engine based on the one or more requests, wherein the symbolic engine constrains responses output by the LLM based on a system graph associated with the process system; receiving, from the symbolic engine, an inferential sequence corresponding to the fault that is represented within the system graph; and/or determining a response to at least one of the one or more requests based on the inferential sequence, among others.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Further, it should be understood that while this disclosure may refer to improving fault diagnostics within a thermal hydraulic system, the techniques of this disclosure can apply to diagnosing faults in any process system.

### Example Computing System

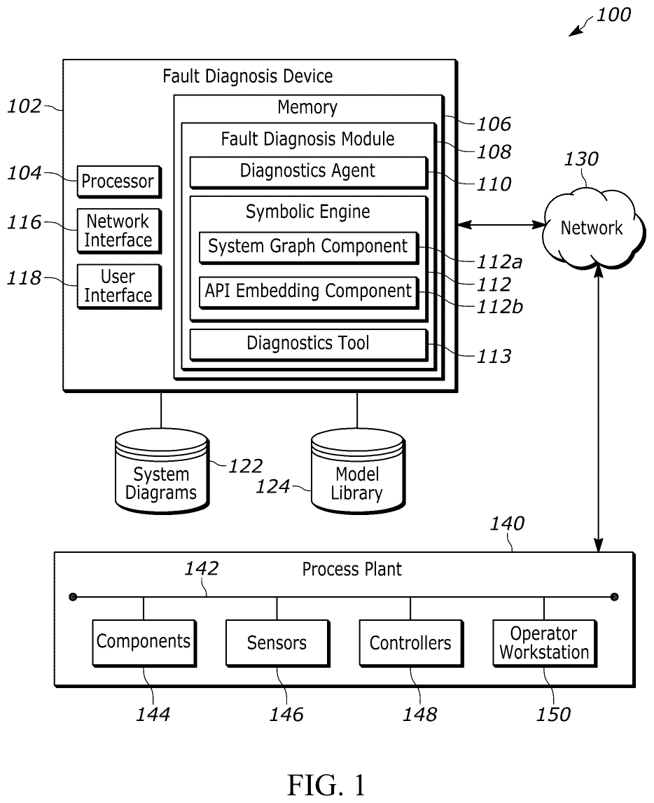

FIG. 1 is a block diagram of an example system 100 configured to implement the techniques of this disclosure for improving fault diagnostics of a process system. It should be appreciated that the system 100 is merely an example and that alternative or additional components are envisioned. The example system 100 includes a fault diagnosis device 102 that is communicatively coupled with a process plant 140 via a network 130. The process plant 140 generally includes components 144 configured to perform a process (e.g., manufacturing process), sensors 146 configured to monitor the components 144 and measurable quantities of the process, controllers 148 to control the components 144 and/or sensors 146, and an operator workstation 150 for plant operators to input requests, view measured data, respond to alerts, and/or otherwise interact with the controllers 148 and/or the fault diagnosis device 102. The fault diagnosis device 102 is generally configured to receive operating data (e.g., sensor data) from the process plant 140 to diagnose faults of the components 144 and/or sensors 146 and to determine response to queries/requests (e.g., received from the operator workstation 150) associated with the diagnosed faults.

As referenced herein, the term “fault” refers to any change in the characteristics of a component and/or a sensor that affects the ability of the component/sensor to perform its designed function. A fault causes an inconsistency between actual, observed behaviors of the component/sensor and behaviors predicted by a (fault-free) model. A particular component/sensor may be capable of experiencing multiple types of faults.

More specifically, under normal operating conditions (i.e., when the process plant 140 is fault-free), the observed data must satisfy constraint relations imposed by the fault-free models. Such constraint relations between observations and the expected component/sensor behaviors are formally defined as analytical redundancy relations (ARRs). Each ARR involves a set of sensor data and certain component(s) of the plant, and each ARR is represented by an equation establishing a constraint among the sensor data. The difference between the two sides of the ARR equation is defined as the residual. A non-zero residual indicates a violation of the ARR, implying at least one of the involved sensors or plant component is faulted.

As an example, some models utilized and/or referenced in the present disclosure are physics-based models based on conservation equations (e.g., conservation of mass, energy, momentum). Any fault in the component/sensor results in an imbalance in these conservation equations, resulting in a difference between the prediction of the physics-based model and the observed value. Such a difference between a prediction of the physics-based model and an observed result is a “fault symptom” indicating a fault, and a “fault diagnosis” is a hypothesis that a set of one or more faults have occurred. Of course, as discussed herein, the techniques of the present disclosure may utilize physics-based models, data-driven models, and/or any other models or combinations thereof.

In any event, the network 130 may include any suitable combination of wired and/or wireless communication network, and may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, cellular network, and others). While FIG. 1 depicts only one network 130, the fault diagnosis device 102 and the process plant 140 may additionally or alternatively communicate via a plurality of networks, depending on the implementation, and still fall within the scope of the present disclosure. For example, the network 130 may include any one or more of an Ethernet-based network, a private network, a cellular network, a local area network (LAN), and/or a wide area network (WAN), such as the Internet.

The fault diagnosis device 102 includes one or more processor(s) 104, which may be general purpose (e.g., CPUs) and/or special purpose processor(s), and a memory 106. The memory 106 may be a non-transitory memory and can include one or several memory modules, such as random access memory (RAM), read-only memory (ROM), flash memory, or other types of persistent memory, etc. The memory 106 can store computer-readable instructions executable on the processor 104. It will be understood that although the fault diagnosis device 102 is illustrated in FIG. 1 as a single device, in general the fault diagnosis device 102 can correspond to multiple computing devices.

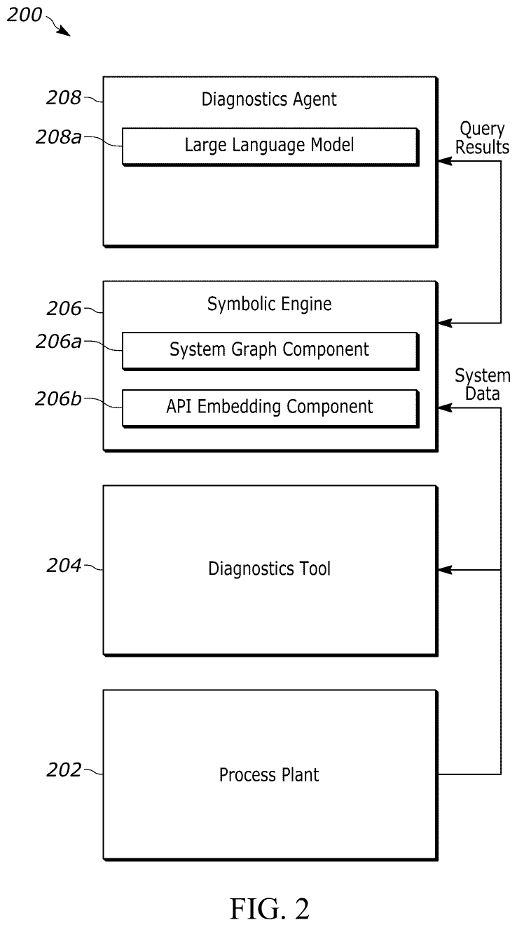

As illustrated in FIG. 1, the memory 106 stores a fault diagnosis module 108. Generally, using the fault diagnosis module 108, the fault diagnosis device 102 configures and applies a physics-based and/or data-driven diagnostic framework, as described herein. As part of this configuration and/or application, the fault diagnosis module 108 may be configured to diagnose faults of the process plant 140, receive requests associated with the faults, determine responses to the requests, and store data objects related to the responses using the techniques discussed below with reference to FIGS. 2-5. In particular, the fault diagnosis module 108 may diagnose faults and, in response to receiving requests associated with the faults, determine responses related to the requests that are constrained by a symbolic engine 112. Further, while the fault diagnosis module 108 is described herein as performing many actions, it should be appreciated that the fault diagnosis module 108 may be or include executable instructions that cause the processors 104 of the fault diagnosis device 102 and/or processors of other suitable devices described herein to perform some/all of these actions.

The fault diagnosis module 108 generally includes a diagnostics agent 110, a symbolic engine 112, and a diagnostics tool 113. The diagnostics agent 110 is or includes a large language model (LLM) that is trained to contextualize sensor data and configurations (e.g., piping and instrumentation diagrams (P&ID)) representing the process plant 140 and query the symbolic engine 112 to provide additional information in response to a request from an operator. The symbolic engine 112 generally creates, updates, and accesses a system graph that represents a corpus of information related to the process plant 140 that is available for responding to requests received at the diagnostics agent 110. The symbolic engine 112 also manages a context window of the diagnostics agent 110 that corresponds to the system graph.

The diagnostics tool 113 is generally configured to diagnose faults occurring within components 144 and/or sensors 146 of the process plant 140. In certain embodiments, the diagnostics tool 113 retrieves or accesses one or more algorithms and/or models stored in the model library 124 to diagnose faults occurring within the process plant 140. Background information related to certain example fault diagnostics that may be performed by the diagnostics tool 113 may be found in U.S. Pat. Nos. 11,740,157 and 11,914,357, the disclosures of which are incorporated herein by reference.

The symbolic engine 112 also includes a system graph component 112a and an application programming interface (API) component 112b. The system graph component 112a generally creates, updates, and/or accesses the system graph. In particular, the system graph component 112a receives system data of the process plant 140 and instantiates the system graph for evaluation as part of the symbolic engine 112. The system data generally includes data associated with sensor data from one or more sensors 146 of the process plant 140, fault data from the diagnostics tool 113, components data of the components 144, residuals output by models applied/executed by the diagnostics tool 113, and/or other suitable data associated with the process plant 140 or combinations thereof. Thus, based on the system data, the system graph created by the system graph component 112a stores connections between residuals, faults, components (e.g., components 144), and sensors (e.g., sensors 146). In certain embodiments, the system graph component 112a updates the system graph to include and/or otherwise indicate statistical and spectral information corresponding to sensor measurements by continuously updating a sensor data buffer.

The API embedding component 112b generally manages the context window of the diagnostics agent 110 that corresponds to the system graph. As mentioned, the diagnostics agent 110 is or includes an LLM, and to interact with an LLM, users/operators must provide tokenized strings, which generally involves splitting the input text into smaller units or strings of “tokens”. LLMs are frequently pretrained, such that the API embedding component 112b must provide any external knowledge (e.g., about the process plant 140 or diagnostics framework) to the LLM of the diagnostics agent 110 in the form of context, but the LLM may only evaluate a certain amount of contextual data (e.g., within a “context window”) at any given time. For example, the size of a context window evaluated by the LLM of the diagnostics agent 110 may be 8192 tokens. Tokens typically represent approximately three-quarters of a single word, so the LLM of the diagnostics agent 110 may evaluate approximately 12 single-spaced pages of text at any given time. This amount of data may be insufficient to adequately answer certain requests and/or may not provide the diagnostics agent 110 with sufficient overall context to understand why a particular response is optimal. Consequently, the API embedding component 112b carefully managing the context window of the LLM of the diagnostics agent 110 is imperative to align the LLM with the requisite knowledge within the system graph and system data to respond to requests associated with faults occurring within the process plant 140.

With continued reference to FIG. 1, and in some embodiments, the fault diagnosis module 108 is stored as computer-readable instructions executable on the processor 104. It should also be noted that although FIG. 1 illustrates the module 108 as stored on the memory 106, the module 108 can also be provided in the form of online services accessible via a web browser executing on the fault diagnosis device 102, as plug-ins or extensions for another software application executing on the fault diagnosis device 102, as instructions on a cloud-based memory, etc.

Further, in some embodiments, functionalities of the fault diagnosis module 108 are performed by different computing devices and/or different applications. As one example, a first computing device may execute the diagnostics tool 113 to determine fault diagnoses using data from the process plant 140, and may provide the fault diagnoses to a second computing device that executes the diagnostics agent 110 and the symbolic engine 112 to generate responses to operator requests related to the faults indicated by the fault diagnoses.

In addition, the fault diagnosis device 102 includes a network interface 116 configured to communicate data with other computing devices and systems, such as the process plant 140, via the network 130. The network interface 116 may include one or more transceivers (e.g., WWAN, WLAN, and/or WPAN transceivers) functioning in accordance with IEEE standards, 3GPP standards, or other communication standards, and configured to receive and transmit data via one or more external ports.

The fault diagnosis device 102 also includes a user interface 118. The user interface 118 includes hardware, firmware, and/or software configured to enable a user to interact with (i.e., both provide inputs to and perceive outputs of) the fault diagnosis device 102. For example, the user interface 118 may include a touchscreen with both display (e.g., video display device) and manual input capabilities. Alternatively, or in addition, the user interface 118 may include a keyboard for accepting user inputs, and/or a microphone (with associated processing components) that provides voice control/input capabilities to the user. As another example, the user interface 118 may include speakers capable of emitting audio. The user interface 118 may include a combination of peripheral devices (e.g., a keyboard and mouse) and one or more display screens. A user may interact with the user interface 118 to configure the fault diagnosis module 108, view and/or provide requests based on responses from the diagnostics agent 110, view fault diagnoses, etc. For example, the fault diagnosis module 108 may implement graphical user interfaces that the fault diagnosis device 102 can display and a user can interact with via the user interface 118.

The fault diagnosis device 102 may be communicatively connected to databases, such as a system diagrams database 122 and a model library 124. The system diagrams database 122 may include diagrams, schematic representations, or textual descriptions of systems. For example, the system diagrams database 122 may store piping and instrumentation diagrams (P&IDs) of systems. A P&ID of a system represents the system as an interconnected collection of components and identifies the locations of sensors. The model library 124 includes descriptions of previously-constructed physics-based models and/or data-driven models, including, for example, the type of component to which the model applies and the sensors required to calibrate the model. The fault diagnosis device 102, and more particularly the diagnostics tool 113, may store the models that the fault diagnosis device 102 constructs in the model library 124 and retrieve models from the model library 124. The databases 122 and 124 may use any known database architecture. Further, one or more of the databases 122 and 124 may be implemented using cloud technology and may reside on a distributed network of computing devices rather than a single computing device. In some embodiments, the fault diagnosis device 102 may store all or portions of the databases 122 and/or 124 in the memory 106.

The fault diagnosis device 102 is communicatively coupled via the network 130 to a system in which faults are to be diagnosed and explained, such as the process plant 140. The process plant 140 may be, for example, a process control plant, a nuclear power plant, a nuclear reactor, a nuclear engineering system, a steam power plant, a thermal power plant or other type of power plant, chemical plant, biomedical plant, pharmaceutical plant, or the like, or a system within these systems.

The various parts of the process plant 140 may be communicatively connected via wired or wireless connections to a data bus 142. The data bus 142 may in turn by communicatively connected to the fault diagnosis device 102 via the network 130. As mentioned, the process plant 140 includes components 144 (e.g., pumps, valves, heat exchangers, heaters, condensers, pipes, junctions, motors, etc.) and sensors 146. In some embodiments, the components 144 may include only a single component (or only a single component of the components 144 may be analyzed). The sensors 146 may monitor conditions of the process plant 140 as a whole or may monitor parameters of the components 144 (e.g., flow rate, temperature, pressure, etc.). The sensors 146 may be affixed onto the components 144 or be installed within or be part of the components 144.

The process plant 140 also includes one or more controllers 148 including control circuitry for controlling the components 144 and the sensors 146. For example, the controllers 148 may control the activation and/or deactivation and modify settings of the components 144 and the sensors 146. Further, the controllers 148 may modify notification settings of the sensors 146 (e.g., what information the sensors 146 provide to the data bus 142 and at what times). The controllers 148 may transmit data and instructions to the components 144 and the sensors 146 via the data bus 142, and may receive information (e.g., responses to the instructions, measurements from the sensors 146) from the components 144 and the sensors 146 via the data bus 142. The controllers 148 also may provide data (e.g., data exchanged with parts of the process plant 140) to the data bus 142. This data may include indications of parts of the process plant 140 that are activated or deactivated (e.g., including timestamps), as well as indications of controlled settings and indications of instances in which controlled settings are modified (e.g., including timestamps).

A user, such as a plant operator, may issue instructions to the controllers 148 and monitor information received from the data bus 142 (e.g., from the controllers 148, components 144, or the sensors 146) via an operator workstation 150. The operator workstation 150 may be a personal computer, a laptop, a smartphone, a tablet, a wearable portable device, etc. Generally, the operator workstation 150 may include a processor, a memory, a network interface, and a user interface (e.g., including a display and user inputs), similar to the fault diagnosis device 102. The process plant 140 may include multiple operator workstations 150 and/or multiple controllers 148. For example, each system component of the components 144 may be associated with a different controller or controllers. Each controller may be associated with one operator workstation, or an operator workstation can be used to configure multiple controllers. The fault diagnosis device 102 can transmit responses to operator requests/queries, fault diagnoses, and/or other output data to the operator workstation, which can display, present, or process the responses, fault diagnoses, and/or output data. Likewise, the operator workstation 150 can manage transmission of input data from the process plant 140 to the fault diagnosis device 102.

The fault diagnosis device 102 may also generate alerts including output data such as a diagnosed fault and/or a response to an operator request/query. The fault diagnosis device 102 may itself present generated alerts to a user of fault diagnosis device 102. For example, the alert may be a notification that can be displayed by a display of the user interface 118 and/or an audio notification that can be emitted by a speaker of the user interface 118. Alternatively, or in addition, the fault diagnosis device 102 can transmit the alert to the operator workstation 150, the controllers 148, or another computing device of the process plant 140. The operator workstation 150 can then display or otherwise present the alert to a user or transmit an indication of the alert to the controllers 148. For example, the operator workstation 150 (or the fault diagnosis device 102) can generate a remedial action (e.g., turn off a faulty component or sensor, redirect flow away from a faulty component or sensor) based on a fault diagnosis, and transmit control instructions to one of the controllers 148 to cause the process plant 140 to perform the remedial action.

It will be understood that the above disclosure is one example and does not necessarily describe every possible embodiment. As such, it will be further understood that alternate embodiments may include fewer, alternate, and/or additional steps or elements.

FIG. 2 is a block data flow diagram 200 including certain components from the system 100 of FIG. 1, in accordance with various embodiments described herein. More specifically, the block data flow diagram 200 represents communications including system data between/among a process plant 202 (e.g., process plant 140) and components of the fault diagnosis module 108 of FIG. 1. The process plant 202 transmits sensor data and/or system diagrams (e.g., P&IDs) to the diagnostics tool 204, which may generate fault diagnoses corresponding to various sensors and/or components of the process plant 202. Of course, as part of the fault diagnosis process performed by the diagnostics tool 204, the tool 204 generates at least one residual (i.e., a non-zero residual) associated with each fault diagnosis.

The diagnostics tool 204 transmits system data including these fault diagnoses, residuals, sensor data, and/or the system diagrams to the symbolic engine 206 to construct and access a system graph. The symbolic engine 206 specifically executes the system graph component 206a to create the system graph using the system data. The system graph generally includes one or more inferential sequences corresponding to the potential faults that can occur within the process plant 202. Namely, each inferential sequence represents causal relations between potential faults in the system and (1) sets of possible fault symptoms (e.g., non-zero residuals) derived from the physics-based ARRs and (2) system data contributing to the possible fault symptoms.

The diagnostics tool 204 determines fault diagnoses by logical inference based on the possible causes of each observed symptom within the process plant 202. These sequences of logical inference to determine fault diagnoses generally comprise diagnostic sequences. In the reverse direction, the system graph component 206a can determine an inferential sequence that includes the fault diagnosis along with the observed symptoms based on the same intuitive causality leveraged by the diagnostics tool 204. Thus, the system graph component 206a generally creates the system graph based on one or more diagnostic sequences performed by the diagnostics tool 204, and each inferential sequence may be a reversed diagnostic sequence.

When the system graph component 206a creates the system graph, the API embedding component 206b can then manage the context window of the LLM 208a. The diagnostics agent 208, and more specifically, the LLM 208a, receives a request/query (e.g., from the operator workstation 150) and may analyze and/or transmit the request/query to the symbolic engine 206. After receiving the request/query, the API embedding component 206b analyzes system data indicated in the system graph created by the system graph component 206a to determine relevant system data based on the request/query. For example, the API embedding component 206b may perform semantic and/or contextual analysis on the request/query and compare the results of such analysis to the system data (e.g., inferential sequences) within the system graph. The API embedding component 206b may consequently determine relevant system data based on system data in the system graph that is the most semantically and/or contextually similar to the request/query. In certain embodiments, the relevant system data includes and/or otherwise indicates an inferential sequence corresponding to a fault indicated in a request received at the diagnostics agent 208.

In any event, the API embedding component 206b then provides the relevant system data to the LLM 208a by including the relevant system data within the context window accessible by the LLM 208a. In some embodiments, the API embedding component 206b may change the context window in response to the LLM 208a determining different responses and/or the LLM 208a determining different portion(s) of a single response. Upon accessing the relevant system data through the context window managed by the API embedding component 206b, the LLM 208a analyzes the relevant system data to determine one or more responses to the request/query. More specifically, the LLM 208a submits a query to the symbolic engine 206, and in response, the engine 206 (e.g., the API embedding component 206b) provides the relevant system data within the context window for the LLM 208a to analyze. Thus, the LLM 208a receives an inferential sequence from the symbolic engine 206 by accessing the relevant system data within the context window and extracting and/or otherwise retrieving the inferential sequences from the relevant system data. The LLM 208a then determines a response to the request (e.g., from the operator workstation 150) based on the inferential sequence.

### Example Residual Dependencies, Inferential Sequences, and Response Determinations

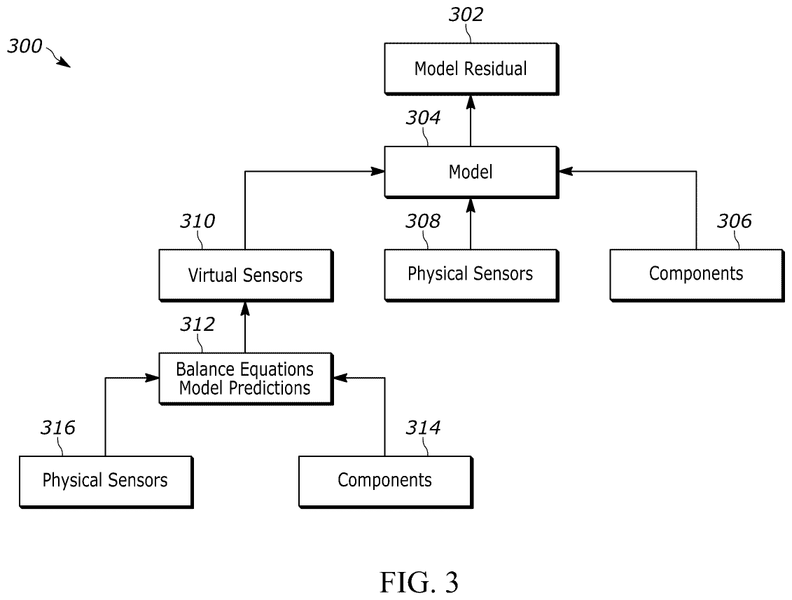

FIG. 3 is an example dependency structure 300 of an example model residual 302, in accordance with various embodiments described herein. As mentioned, the set of model residuals forms the basis for fault diagnostics for any process system (e.g., process plant 140). Each non-zero residual serves as a fault symptom that implicates certain system faults (i.e., faults of a component and/or sensor). A fault diagnosis device (e.g., fault diagnosis device 102 using diagnostics tool 113) can identify possible causes of each non-zero residual, and by extension, a corresponding set of faults, from the underlying ARRs representing operating principles of the associated components. The fault diagnosis device may thereby detect and diagnose faults for a given process system at any given time based on observed symptoms (e.g., using system data).

Broadly speaking, the dependency structure 300 of FIG. 3 represents dependencies between/among various portions of the fault diagnosis process performed, for example, by the fault diagnosis device 102 of FIG. 1 to determine a model residual 302. In certain instances, this model residual 302 is non-zero, and thus serves as a fault symptom that implicates certain system faults of a process system (e.g., process plant 140). More specifically, the fault diagnosis device 102 determines the model residual 302 as a result of executing/applying a model 304 to data (e.g., system data) indicating operation(s) of various portions of the process system.

The system data generally includes data indicating the operation/performance of system components 306, physical sensors 308, and virtual sensors 310. As previously discussed, the system components 306 may generally include physical components configured to perform a function as part of a process of the process plant. For example, in scenarios where the process plant is a power plant, the system components 306 can include pumps, valves, heat exchangers, heaters, condensers, pipes, junctions, motors, and/or other physical components. Similarly, the physical sensors 308 generally include physical devices configured to measure process variables (i.e., physical quantities) related to the performance of the process of the process plant. In the power plant example, the physical sensors 308 may be physical devices disposed proximate to the system components 306 and/or otherwise configured to measure temperature, pressure, flow rate, and/or other process variables.

The virtual sensors 310 are generally non-physical constructs that the fault diagnosis device 102 (or other suitable device) obtains analytically for unmeasured process variables for use in place of missing physical sensors 308. Generally, the fault diagnosis device 102 solves conservation equations and related constitutive equations governing operation of the process plant to obtain the virtual sensors 310. In particular, the fault diagnosis device 102 receives data from associated physical components 314 and associated physical sensors 316 and evaluates model predictions and balance equations 312 using that data. By obtaining the virtual sensors 310, the fault diagnosis device 102 can construct diagnostic models (e.g., model 304) that provide maximum coverage over the individual processes included as part of performing the process of the process plant. Moreover, the validity of each virtual sensor 310 is dependent on the health status of the associated system components 306 and physical sensors 308 involved in the underlying analytical solution obtained by the fault diagnosis device 102.

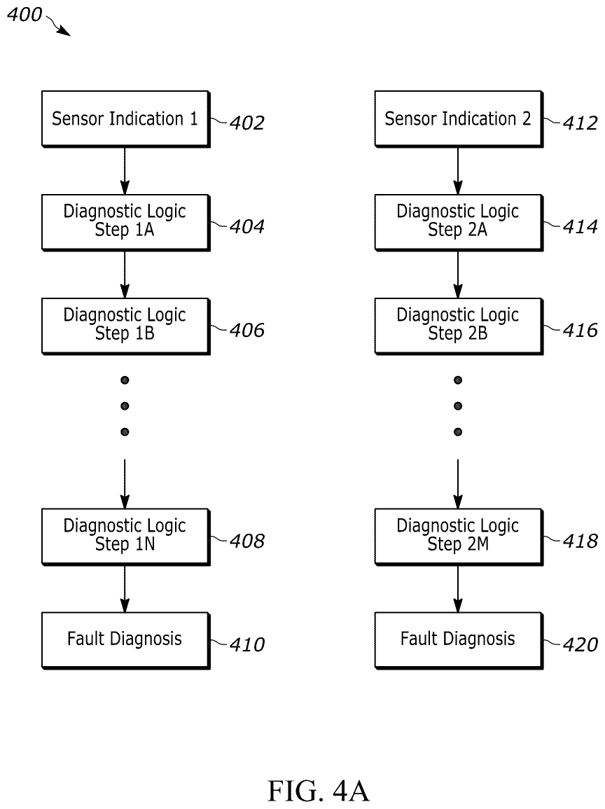

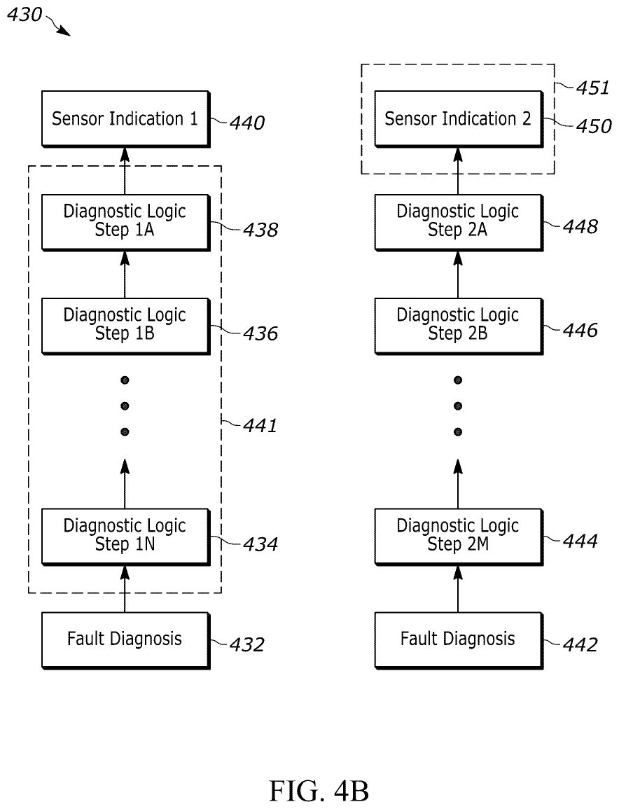

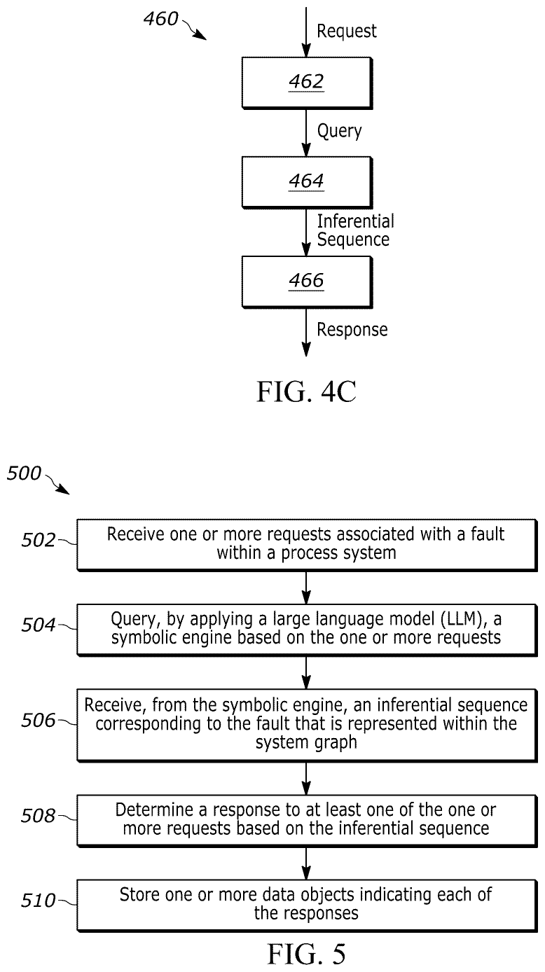

Thus, the example dependency structure 300 broadly illustrates the relationships between system data and model residuals, which the fault diagnosis device 102 uses to diagnose faults within a process plant. However, once the fault diagnosis device 102 determines a model residual 302, the device 102 must then further evaluate the cause-effect relationships that dictate why particular non-zero residuals indicate a particular fault diagnosis. To provide a better understanding of the logical sequencing performed by the fault diagnosis device 102 to reach fault diagnoses, FIG. 4A depicts two example diagnostic sequences performed by a diagnostics tool (e.g., diagnostics tool 113), in accordance with various embodiments described herein.

Generally, each fault diagnosis 410, 420 corresponds to one or more unique residual signatures that are comprised at least of non-zero residuals associated with components/sensors of the modeled system (e.g., process plant 140). Thus, each set of non-zero residuals the diagnostics tool 113 determines for a particular system/subsystem necessarily indicates a unique fault diagnosis. FIG. 4A illustrates a logic sequence 400 whereby a diagnostics tool performs two diagnostic sequences to reach two, distinct fault diagnoses 410, 420.

A first diagnostic sequence is generally defined by the blocks 402-410, and a second diagnostic sequence is generally defined by the blocks 412-420. The first diagnostic sequence includes a first sensor indication 402 that, when received by the diagnostics tool, causes the diagnostics tool to perform the diagnostic logic steps 404-408 to ultimately reach the fault diagnosis 410. Similarly, the second diagnostic sequence includes a second sensor indication 412 that, when received by the diagnostics tool, causes the diagnostics tool to perform the diagnostic logic steps 414-418 to ultimately reach the fault diagnosis 420. In certain embodiments, the diagnostics tool may not perform the diagnostic logic steps 404-408, 414-418 in response to receiving the sensor indications 402, 412, and may instead perform such logic steps in response to receiving a fault diagnosis signal from another component (e.g., instructions included as part of the fault diagnosis module 108) and/or in response to any other suitable criteria. Further, the diagnostics tool may perform a first diagnostic logic step (e.g., 404, 414) to evaluate a model residual using the sensor indication (e.g., 402, 412), and may proceed with performing subsequent logic steps in response to determining that the model residual is non-zero.

For example, the first sensor indication 402 may represent the pressure measured at an outlet of a particular gas chamber, and the indication 402 may indicate that the pressure is exceeding a corresponding threshold value. The diagnostics tool receives this first sensor indication 402 and proceeds to perform diagnostic logic step 1A (block 404), which may represent evaluating a physics-based model corresponding to the gas chamber using the first sensor indication 402. The diagnostics tool may determine a model residual as a result of performing diagnostic logic step 1A (block 404), and this model residual may be non-zero. The diagnostics tool may subsequently evaluate other models (e.g., physics-based models) associated with the gas chamber to determine other model residuals, and this other model evaluation may comprise diagnostic steps 1B (block 406) through 1N-1, where N is any integer value. With all relevant model residuals, the diagnostics tool can then proceed to evaluate the model residuals (e.g., the residual signature) as diagnostic logic step 1N (block 408) to determine the fault diagnosis 410 corresponding to the residual signature. Accordingly, the fault diagnosis 410 may indicate that a fault is present within a pressure sensor and/or a component of the gas chamber.

As another example, the second sensor indication 412 may represent the flow rate measured at a fluid flow valve, and the indication 412 may indicate that the flow rate is below a corresponding threshold value. The diagnostics tool receives this second sensor indication 412 and proceeds to perform diagnostic logic step 2A (block 414), which may represent evaluating a physics-based model corresponding to the fluid flow valve using the second sensor indication 412. The diagnostics tool may determine a model residual as a result of performing diagnostic logic step 2A (block 414), and this model residual may be non-zero. The diagnostics tool may subsequently evaluate other models (e.g., physics-based models) associated with the fluid flow valve to determine other model residuals, and this other model evaluation may comprise diagnostic steps 2B (block 416) through 1M-1, where M is any integer value. With all relevant model residuals, the diagnostics tool can then proceed to evaluate the model residuals (e.g., the residual signature) as diagnostic logic step 1M (block 418) to determine the fault diagnosis 420 corresponding to the residual signature. Accordingly, the fault diagnosis 420 may indicate that a fault is present within a flow rate sensor and/or a component of the fluid flow valve.

In certain embodiments, the diagnostics tool 113 may reach the fault diagnoses 410, 420 by performing two or more different sets of diagnostic logic steps. As an example, the fault diagnosis 410 may indicate that a temperature sensor has failed within the process plant. In theory, such a diagnosis 410 could stem at least from (1) a first sensor indication 402 that the temperature at a port monitored by the temperature sensor is above/below a threshold when all other operating parameters are normal or (2) that the first sensor indication 402 is within normal tolerances when all other operating parameters are not (i.e., a total component failure). Thus, the diagnostics tool 113 can arrive at the fault diagnosis 410 based on at least two different sets of diagnostic logic steps, such that the corresponding diagnostic path for the fault diagnosis 410 included as part of the system graph includes at least these two sets of diagnostic logic steps resulting in an identical fault diagnosis 410.

The fault diagnosis device (e.g., device 102) may display information and/or alerts corresponding to the fault diagnoses 410, 420 to an operator, and the operators may input requests associated with the diagnoses 410, 420. The diagnostics agent and symbolic engine may generally determine responses to such requests, in accordance with data indicated by the system graph. The system graph generally includes system data represented in the form of reversed diagnostic sequences performed by the diagnostics tool, and these reversed diagnostic sequences enable the diagnostics agent and symbolic engine to determine responses to the operator requests based on the logical evaluations performed by the diagnostics tool. To illustrate, FIG. 4B depicts two example reversed diagnostic sequences represented within a system graph, in accordance with various embodiments described herein.

More specifically, FIG. 4B illustrates a reverse logic sequence 430 whereby a diagnostics agent (e.g., diagnostics agent 110) and/or a symbolic engine (e.g., symbolic engine 112) analyzes two reverse diagnostic sequences to determine relevant system data associated with the distinct fault diagnoses 432, 442. In some embodiments, the reverse diagnostic sequences comprised of blocks 432-440 and blocks 442-450 are portions of a system graph that represents (1) the complete set of diagnostic logical steps performed by a diagnostics tool and (2) the corresponding system data analyzed by the diagnostics tool to determine any fault diagnosis associated with a system (e.g., process plant 140) and/or subsystem thereof.

In response to receiving a request from an operator, the diagnostics agent may query the symbolic engine to determine/manage a context window within the system graph. The symbolic engine may define a context window 441, 451 including system data included and/or indicated by one or more reverse diagnostic sequences, within which, the diagnostics agent may access the included/indicated system data to determine a response to an operator request. The reverse diagnostic sequences may generally correspond to portions of the system graph, such that the sequences also indicate system data corresponding to processes of the process system. Thus, the symbolic engine constrains the responses output by the diagnostics agent to only include information/data that is included in or clearly indicated by the system data. In this manner, the symbolic engine prevents the diagnostics agent from determining responses that include hallucinations, and thereby improves over conventional techniques that suffer from such hallucinations.

Regardless, as an example, the diagnostics agent may receive a request associated with a fault represented by the fault diagnosis 432 and may generate and transmit a query to the symbolic engine indicating system data that may be required related to the fault diagnosis 432 based on the request. The symbolic engine may then evaluate some/all of the first reverse diagnostic sequence (e.g., blocks 432-440) to determine a context window 441 for the diagnostics agent. The symbolic engine evaluates the query provided by the diagnostics agent and determines types of system data that may be relevant based on the query. Namely, the query provided by the diagnostics agent related to the first reverse diagnostic sequence may request information related to logical steps performed by the diagnostics tool that eliminated certain fault diagnoses (e.g., other than fault diagnosis 432) from consideration. In response, the symbolic engine may determine a context window 441 that focuses on information from the first reverse diagnostic sequence related to residual determinations and residual signature evaluations/analysis (e.g., blocks 434-438). The diagnostics agent may evaluate some/all of the system data contained within and/or otherwise associated with the diagnostic logical steps 434-438 within the context window 441 to determine a response to the request.

As another example, the diagnostics agent may receive a request associated with a fault represented by the fault diagnosis 442 and may generate and transmit a query to the symbolic engine indicating system data that may be required related to the fault diagnosis 442 based on the request. The symbolic engine may then evaluate some/all of the second reverse diagnostic sequence (e.g., blocks 442-450) to determine a context window 451 for the diagnostics agent. The symbolic engine evaluates the query provided by the diagnostics agent and determines types of system data that may be relevant based on the query. Namely, the query provided by the diagnostics agent related to the second reverse diagnostic sequence may request information related to sensor data received and analyzed by the diagnostics tool. In response, the symbolic engine may determine a context window 451 that focuses on the received sensor data in the second reverse diagnostic sequence (e.g., block 450). The diagnostics agent may evaluate some/all of the system data contained within and/or otherwise associated with the sensor indications 450 within the context window 451 to determine a response to the request.

FIG. 4C is a block data flow diagram representing an improved fault diagnostics process 460, in accordance with various embodiments described herein. Generally speaking, the improved fault diagnostics process 460 represents a sequence of actions a fault diagnostics device (e.g., device 102) performs to determine a response to a request associated with a diagnosed fault within a process system (e.g., process plant 140). The process 460 generally includes a query stage 462, an inferential sequence stage 464, and a response stage 466.

The query stage 462 includes receiving a request as an input and generating a query as an output. More specifically, a diagnostics agent (e.g., agent 110) receives a request that is associated with a diagnosed fault within a process system, and the agent generates a query configured to cause a symbolic engine (e.g., engine 112) to access system data included in a system graph. The diagnostics agent may format and/or otherwise generate the query based on the request, for example, by extracting keywords from the request and/or formatting the query in accordance with a protocol or structure that is suitable for input into the symbolic engine.

The inferential sequence stage 464 includes receiving the query as an input and returning an inferential sequence as an output. A symbolic engine (e.g., engine 112) may perform the steps included in the inferential sequence stage 464, and may interpret the query through semantic analysis, syntactic analysis, contextual analysis, rules-based analysis in accordance with a protocol/structure, and/or using any other suitable method to determine types of system data that are relevant to the query. The symbolic engine then determines and manages a context window of/for the diagnostics agent that includes one or more inferential sequences and/or portions of the inferential sequences. Each inferential sequence and/or inferential sequence portion included in the context window includes and/or otherwise indicates system data the diagnostics agent may use to determine a response. Thus, the symbolic engine may return an inferential sequence to the diagnostics agent as an output of the inferential sequence stage 464 by including the relevant inferential sequence and/or portion thereof in the context window accessed by the diagnostics agent.

The response stage 466 includes receiving an inferential sequence as an input and determining a response as an output. The diagnostics agent (e.g., agent 110) receives the inferential sequence by accessing the sequence and system data indicated and/or included therein through the context window managed by the symbolic engine. The agent then analyzes the inferential sequence or portion(s) thereof and the system data indicated and/or included therein to determine the system data within the context window that most closely corresponds to the content of the request, and determines a response based on that system data. In certain embodiments, the diagnostics agent determines that system data closely corresponds to the content of the request based on a predicted contextual, semantic, and/or syntactic similarity of the system data to the language of the request. Further, in some embodiments, the fault diagnosis device displays or causes another computing device (e.g., operator workstation 150) to display the response determined as part of the response stage 466.

### Example Computer-Implemented Methods

FIG. 5 depicts a flow diagram representing an example computer-implemented method 500, in accordance with various embodiments described herein. The method 500 may be implemented by one or more processors of the example system 100, such as the processor 104 of fault diagnosis device 102, for example.

The method 500 includes receiving one or more requests associated with a fault within a process system (block 502). The method 500 further includes applying an LLM to the one or more requests by querying a symbolic engine based on the one or more requests (block 504). The symbolic engine constrains responses output by the LLM based on a system graph associated with the process system.

The method 500 further includes applying the LLM to the one or more requests by receiving, from the symbolic engine, an inferential sequence corresponding to the fault that is represented within the system graph (block 506). The method 500 further includes applying the LLM to the one or more requests by determining a response to at least one of the one or more requests based on the inferential sequence (block 508). The method 500 further includes storing one or more data objects indicating each of the responses (block 510).

In certain embodiments, the method 500 includes applying the LLM to the one or more requests by determining, by the symbolic engine, the inferential sequence corresponding to the fault based on a diagnostic sequence indicated in the system graph.

In some embodiments the method 500 further includes creating, by the symbolic engine, the system graph based on one or more diagnostic sequences performed by a diagnostics tool associated with the process system. Further in these embodiments, the inferential sequence corresponding to the fault is a reversed diagnostic sequence based on one of the one or more diagnostic sequences.

In certain embodiments, the symbolic engine includes a system graph component and an application programming interface (API) embedding component. Further in these embodiments, the system graph component is configured to: aggregate system data of the process system associated with at least one of: (i) one or more faults, (ii) one or more components, (iii) one or more sensors, or (iv) one or more residuals; and instantiate the system graph for evaluation as part of the symbolic engine. Still further in these embodiments, the API embedding component is configured to embed an LLM API associated with the LLM within the symbolic engine; and manage a context window of the LLM corresponding to the system graph. Moreover, managing the context window of the LLM includes analyzing system data of the process system indicated in the system graph to determine relevant system data; and providing the relevant system data to the LLM.

In some embodiments, each response determined by the LLM includes a human-readable explanation associated with the fault.

In certain embodiments, each request received at the one or more processors includes a human-readable portion associated with the fault.

In some embodiments, the method 500 further includes determining, by the one or more processors, an action to address the fault; and generating, by the one or more processors, each data object of the one or more data objects to include the action to address the fault.

Further in these embodiments, the method 500 includes transmitting, by the one or more processors, a control instruction to a controller of the process system to perform the action.

Of course, it is to be appreciated that the actions of the method 500 may be performed any suitable number of times, and that the actions described in reference to the method 500 may be performed in any suitable order.

### Example Input-Output Sequences Utilizing a Diagnostics Agent

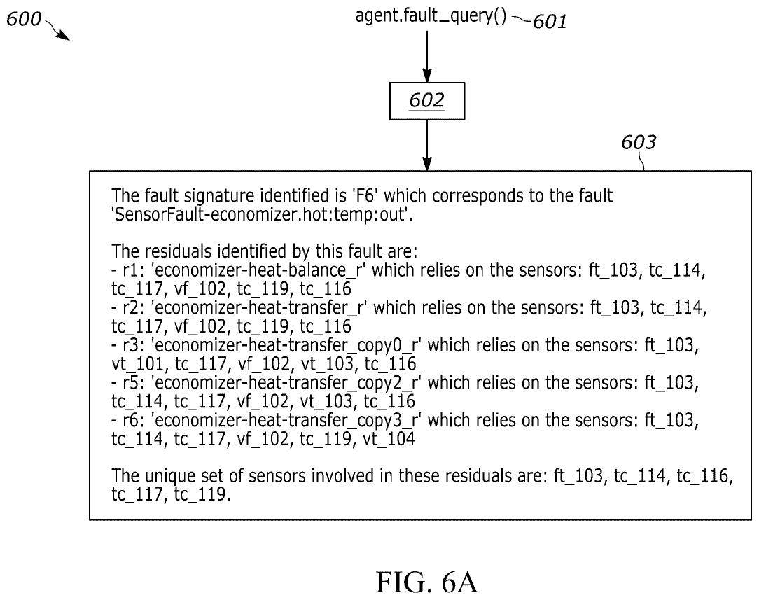

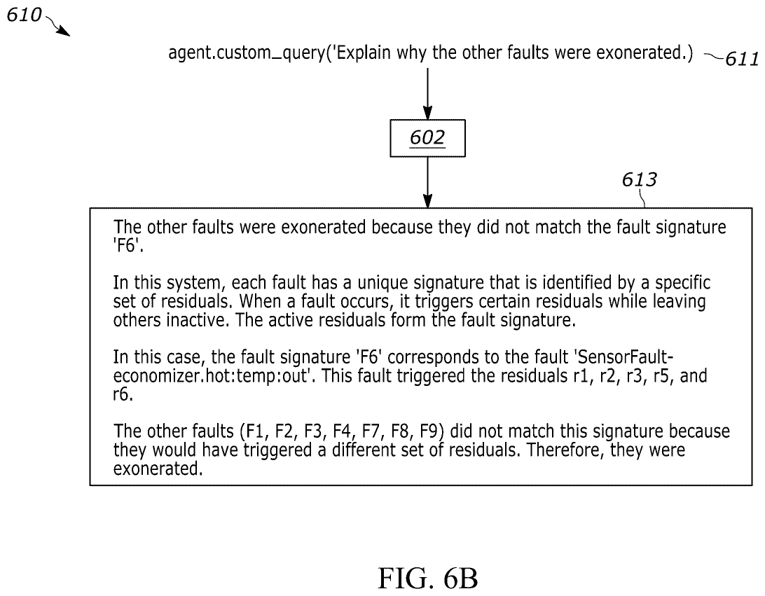

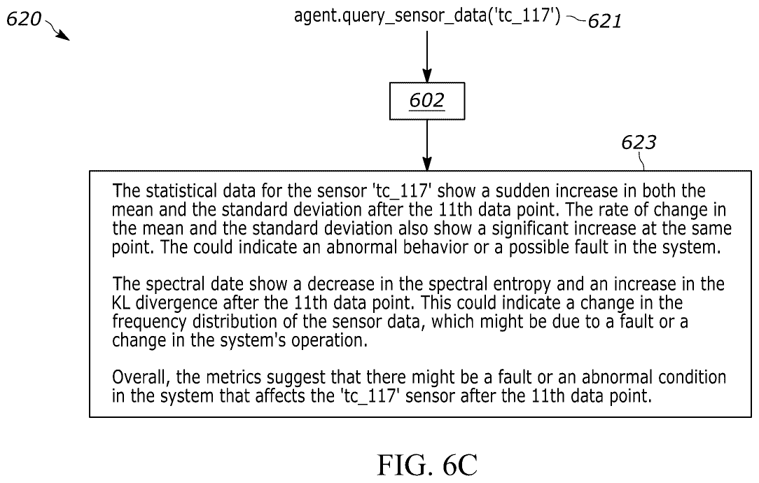

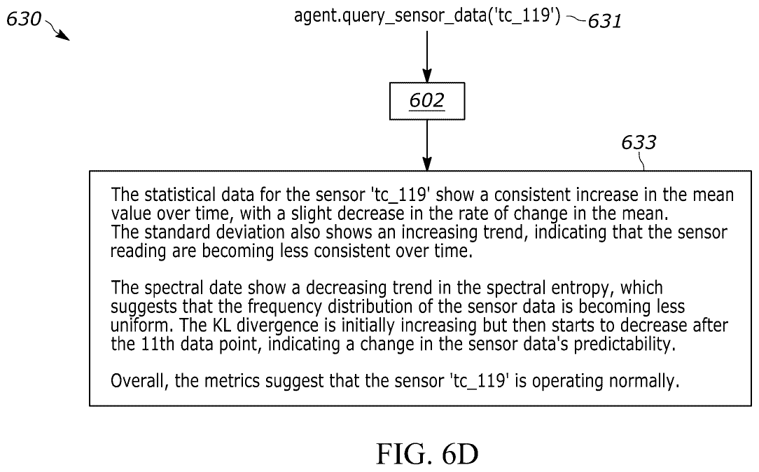

FIGS. 6A-6D depict example input-output sequences of an operator submitting requests to the diagnostics agent, in accordance with various embodiments described herein.

FIG. 6A depicts an example fault query sequence 600 that involves an operator requesting clarification regarding a fault identified for a process system. Generally, the example fault query sequence 600 includes an input request 601, a request processing stage 602, and an output response 603. In certain embodiments, components of the example system 100 (e.g., fault diagnosis device 102) may perform some/all of the functions described herein in reference to the example fault query sequence 600.

As illustrated in FIG. 6A, the input request 601 states “agent. fault_query( )”, which may be a pre-determined input format configured to return explanatory information related to a diagnosed fault in a human-readable explanation. The request processing stage 602 includes evaluating the input request 601, determining a relevant inferential sequence and associated system data, and determining the output response 603 (as constrained by the system graph and system data).

The output response 603 indicates, in part, “The fault signature identified is ‘F6’ which corresponds to the fault ‘SensorFault-economizer.hot:temp:out’.” Notably, the output response 603 includes a human-readable explanation associated with the fault. Additionally, the request processing stage 602 may determine and provide supporting system data as part of the output response 603, and as constrained by the system graph. For example, the output response 603 also indicates residuals identified by the fault, and further indicates the unique set of sensors involved in each of the residuals.

FIG. 6B depicts an example custom query sequence 610 that involves an operator requesting clarification regarding why other faults were exonerated during the fault diagnostics process for a fault of a process system. Generally, the example custom query sequence 610 includes an input request 611, the request processing stage 602, and an output response 613. In certain embodiments, components of the example system 100 (e.g., fault diagnosis device 102) may perform some/all of the functions described herein in reference to the example custom query sequence 610.

As illustrated in FIG. 6B, the input request 611 states “agent custom_query(‘Explain why the other faults were exonerated.)”, which may be a custom, human-readable input format configured to return explanatory information related to exonerated faults in a human-readable explanation. The input request 611 includes a human-readable portion (i.e., “Explain why the other faults were exonerated”), such that the operator may submit the input request 601 in a semi natural language format, which reduces the burden on such operators to learn tedious, program-specific query formatting rules. The request processing stage 602 includes evaluating the input request 611, determining a relevant inferential sequence and associated system data, and determining the output response 613 (as constrained by the system graph and system data).

The output response 613 indicates, in part, “The other faults were exonerated because they did not match the fault signature ‘F6’.” Notably, the output response 613 includes a human-readable explanation associated with the exonerated faults. Additionally, the request processing stage 602 may determine and provide supporting system data as part of the output response 613. For example, the output response 613 also indicates that each fault has a unique signature triggered by a specific set of residuals, the fault signature “F6” has a corresponding fault “SensorFault-economiser.hot:temp:out” associated with residuals “r1, r2, r3,r5, and r6”, and the other faults did not match this signature and were therefore exonerated.

FIG. 6C depicts an example sensor data query sequence 620 that involves an operator requesting sensor data associated with a particular sensor that may be relevant to a fault diagnosed in a process system. Generally, the example sensor data query sequence 620 includes an input request 621, the request processing stage 602, and an output response 623. In certain embodiments, components of the example system 100 (e.g., fault diagnosis device 102) may perform some/all of the functions described herein in reference to the example sensor data query sequence 620.

As illustrated in FIG. 6C, the input request 621 states “agent.query_sensor_data(‘tc_117’.)”, which may be a pre-determined input format configured to return explanatory information related to sensor data of a sensor in a human-readable explanation. The request processing stage 602 includes evaluating the input request 621, determining a relevant inferential sequence and associated system data, and determining the output response 623 (as constrained by the system graph and system data).

The output response 623 indicates, in part, “The statistical data for the sensor ‘tc_117’ show a sudden increase in both the mean and standard deviation after the 11th data point. The rate of change in the mean and the standard deviation also show a significant increase at the same point. This could indicate an abnormal behavior or a possible fault in the system.” Notably, the output response 623 includes a human-readable explanation associated with the sensor data of sensor “tc_117”.

Additionally, the request processing stage 602 may determine and provide supporting system data as part of the output response 623. For example, the output response 623 also indicates that “[t]he spectral data show a decrease in the spectral entropy and an increase in the KL divergence after the 11th data point. This could indicate a change in the frequency distribution of the sensor data, which might be due to a fault or a change in the system's operation. Overall, the metrics suggest that there might be a fault or an abnormal condition in the system that affects the ‘tc_117’ sensor after the 11th data point.” FIG. 6D depicts another example sensor data query sequence 630 that involves an operator requesting sensor data associated with a particular sensor that may be operating normally despite a fault diagnosed in a process system. Generally, the example sensor data query sequence 630 includes an input request 631, the request processing stage 602, and an output response 633. In certain embodiments, components of the example system 100 (e.g., fault diagnosis device 102) may perform some/all of the functions described herein in reference to the example sensor data query sequence 630.

As illustrated in FIG. 6D, the input request 631 states “agent.query_sensor_data(‘tc_119’.)”, which may be a pre-determined input format configured to return explanatory information related to sensor data of a sensor in a human-readable explanation. The request processing stage 602 includes evaluating the input request 631, determining a relevant inferential sequence and associated system data, and determining the output response 633 (as constrained by the system graph and system data).

The output response 633 indicates, in part, “The statistical data for the sensor ‘tc_119’ show a consistent increase in the mean value over time, with a slight decrease in the rate of change in the mean. The standard deviation also shows an increasing trend, indicating that the sensor readings are becoming less consistent over time.” Notably, the output response 633 includes a human-readable explanation associated with the sensor data of sensor “tc_119”.

Additionally, the request processing stage 602 may determine and provide supporting system data as part of the output response 633. For example, the output response 633 also indicates that “[t]he spectral data show a decreasing trend in the spectral entropy, which suggest that the frequency distribution of the sensor data is becoming less uniform. The KL divergence is initially increasing but then starts to decrease after the 11th data point, indicating a change in the sensor data's predictability. Overall, the metrics suggest that the sensor ‘tc_119’ is operating normally.”

Each of the responses 603, 613, 623, 633 represented in FIGS. 6A-6D, and other responses discussed herein, may be included and/or otherwise indicated in one or more data objects stored in the memory (e.g., memory 106) of a fault diagnosis device (e.g., device 102). Such data objects may include the text of the responses, links to system data referenced in such responses, and/or any other information/data included in and/or otherwise referenced or indicated in such responses. In certain embodiments, the fault diagnosis device generates and stores data objects related to each response after the device determines the responses. In some embodiments, the fault diagnosis device generates and stores data objects related to responses in a batch or periodic manner, such that multiple response may be represented in a single data object. Thus, in either case, operators may access the data objects to review, interact with, and/or otherwise analyze the information/data included in and/or otherwise referenced or indicated in prior responses.

### ASPECTS

The following list of aspects reflects a variety of the embodiments explicitly contemplated by the present disclosure. Those of ordinary skill in the art will readily appreciate that the aspects below are neither limiting of the embodiments disclosed herein, nor exhaustive of all of the embodiments conceivable from the disclosure above, but are instead meant to be exemplary in nature.

Aspect 1. A method for diagnosing faults, the method comprising: receiving, at one or more processors, one or more requests associated with a fault within a process system; applying, by the one or more processors, a large language model (LLM) to the one or more requests, wherein applying the LLM includes querying a symbolic engine based on the one or more requests, wherein the symbolic engine constrains responses output by the LLM based on a system graph associated with the process system, receiving, from the symbolic engine, an inferential sequence corresponding to the fault that is represented within the system graph, and determining a response to at least one of the one or more requests based on the inferential sequence; and storing, by the one or more processors, one or more data objects indicating each of the responses.

Aspect 2. The method of aspect 1, wherein applying the LLM to the one or more requests further includes: determining, by the symbolic engine, the inferential sequence corresponding to the fault based on a diagnostic sequence indicated in the system graph.

Aspect 3. The method of any of aspects 1 or 2, further comprising: creating, by the symbolic engine, the system graph based on one or more diagnostic sequences performed by a diagnostics tool associated with the process system.

Aspect 4. The method of aspect 3, wherein the inferential sequence corresponding to the fault is a reversed diagnostic sequence based on one of the one or more diagnostic sequences.

Aspect 5. The method of any of aspects 1 through 4, wherein the symbolic engine includes a system graph component and an application programming interface (API) embedding component.

Aspect 6. The method of aspect 5, wherein the system graph component is configured to: aggregate system data of the process system associated with at least one of: (i) one or more faults, (ii) one or more components, (iii) one or more sensors, or (iv) one or more residuals; and instantiate the system graph for evaluation as part of the symbolic engine.

Aspect 7. The method of aspect 5, wherein the API embedding component is configured to: embed an LLM API associated with the LLM within the symbolic engine; and manage a context window of the LLM corresponding to the system graph.

Aspect 8. The method of aspect 7, wherein managing the context window of the LLM includes: analyzing system data of the process system indicated in the system graph to determine relevant system data; and providing the relevant system data to the LLM.

Aspect 9. The method of any of aspects 1 through 8, wherein each response determined by the LLM includes a human-readable explanation associated with the fault.

Aspect 10. The method of any of aspects 1 through 9, wherein each request received at the one or more processors includes a human-readable portion associated with the fault.

Aspect 11. The method of any of aspects 1 through 10, further comprising: determining, by the one or more processors, an action to address the fault; and generating, by the one or more processors, each data object of the one or more data objects to include the action to address the fault.

Aspect 12. The method of aspect 11, further comprising: transmitting, by the one or more processors, a control instruction to a controller of the process system to perform the action.

Aspect 13. A computer system for improving fault diagnostics, the computer system comprising: one or more processors; and a non-transitory computer-readable medium storing thereon instructions that, when executed by the one or more processors, cause the computer system to: receive one or more requests associated with a fault within a process system, apply a large language model (LLM) to the one or more requests, wherein applying the LLM includes querying a symbolic engine based on the one or more requests, wherein the symbolic engine constrains responses output by the LLM based on a system graph associated with the process system, receiving, from the symbolic engine, an inferential sequence corresponding to the fault that is represented within the system graph, and determining a response to at least one of the one or more requests based on the inferential sequence, and store one or more data objects indicating each of the responses.

Aspect 14. The computer system of aspect 13, wherein the instructions, when executed, further cause the computer system to apply the LLM to the one or more requests by: determining, by the symbolic engine, the inferential sequence corresponding to the fault based on a diagnostic sequence indicated in the system graph.

Aspect 15. The computer system of any of aspects 13 or 14, wherein the instructions, when executed, further cause the computer system to: create, by the symbolic engine, the system graph based on one or more diagnostic sequences performed by a diagnostics tool associated with the process system.

Aspect 16. The computer system of aspect 15, wherein the inferential sequence corresponding to the fault is a reversed diagnostic sequence based on one of the one or more diagnostic sequences.

Aspect 17. The computer system of any of aspects 13 through 16, wherein the symbolic engine includes a system graph component and an application programming interface (API) embedding component.

Aspect 18. The computer system of aspect 17, wherein the system graph component is configured to: aggregate system data of the process system associated with at least one of: (i) one or more faults, (ii) one or more components, (iii) one or more sensors, or (iv) one or more residuals; and instantiate the system graph for evaluation as part of the symbolic engine.

Aspect 19. The computer system of aspect 17, wherein the API embedding component is configured to: embed an LLM API associated with the LLM within the symbolic engine; and manage a context window of the LLM corresponding to the system graph by analyzing system data of the process system indicated in the system graph to determine relevant system data, and providing the relevant system data to the LLM.

Aspect 20. A non-transitory computer-readable storage medium including instructions that, when executed by one or more processors, cause the one or more processors to: receive one or more requests associated with a fault within a process system; apply a large language model (LLM) to the one or more requests, wherein applying the LLM includes querying a symbolic engine based on the one or more requests, wherein the symbolic engine constrains responses output by the LLM based on a system graph associated with the process system, receiving, from the symbolic engine, an inferential sequence corresponding to the fault that is represented within the system graph, and determining a response to at least one of the one or more requests based on the inferential sequence; and store one or more data objects indicating each of the responses.

### Additional Considerations

The following additional considerations apply to the foregoing discussion. Throughout this specification, plural instances may implement functions, components, operations, or structures described as a single instance. Although individual functions and instructions of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of functions, components, modules, blocks, or mechanisms. Functions may constitute either software modules (e.g., non-transitory code stored on a tangible machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Accordingly, the term hardware should be understood to encompass a tangible entity, which may be one of an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules may provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and may operate on a resource (e.g., a collection of information).

The various operations of exemplary functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or functions described herein may be at least partially processor-implemented. For example, at least some of the functions of a method may be performed by one or more processors or processor-implemented hardware modules. The performance of certain of the functions may be distributed among the one or more processors, not only residing within a single machine, but deployed across a number of machines. In some exemplary embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors). These operations are accessible via a network (e.g., the Internet) and via one or more appropriate interfaces (e.g., application program interfaces (APIs)).

The performance of certain operations may be distributed among the one or more processors, not only residing within a single machine, but deployed across a number of machines. In some exemplary embodiments, the one or more processors or processor-implemented modules may be located in a single geographic location (e.g., within a home environment, an office environment, or a server farm). In other exemplary embodiments, the one or more processors or processor-implemented modules may be distributed across a number of geographic locations.

Some portions of this specification are presented in terms of algorithms or symbolic representations of operations on data and data structures stored as bits or binary digital signals within a machine memory (e.g., a computer memory). These algorithms or symbolic representations are examples of techniques used by those of ordinary skill in the data processing arts to convey the substance of their work to others skilled in the art. As used herein, a “function” or an “algorithm” or a “routine” is a self-consistent sequence of operations or similar processing leading to a desired result. In this context, functions, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a function, process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a system 100 for purposes of illustration only. One of ordinary skill in the art will readily recognize from the following discussion that alternative embodiments of the structures and methods illustrated herein may be employed without departing from the principles described herein.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the techniques disclosed herein without departing from the spirit and scope defined in the appended claims.

What is claimed is:

1. A method for improving fault diagnostics, the method comprising:
receiving, at one or more processors, one or more requests associated with a fault within a process system;
applying, by the one or more processors, a large language model (LLM) to the one or more requests, wherein applying the LLM includes:
querying a symbolic engine based on the one or more requests, wherein the symbolic engine constrains responses output by the LLM based on a system graph associated with the process system,
receiving, from the symbolic engine, an inferential sequence corresponding to the fault that is represented within the system graph, and
determining a response to at least one of the one or more requests based on the inferential sequence; and
storing, by the one or more processors, one or more data objects indicating each of the responses.

2. The method of claim 1, wherein applying the LLM to the one or more requests further includes:
determining, by the symbolic engine, the inferential sequence corresponding to the fault based on a diagnostic sequence indicated in the system graph.

3. The method of claim 1, further comprising:
creating, by the symbolic engine, the system graph based on one or more diagnostic sequences performed by a diagnostics tool associated with the process system.

4. The method of claim 3, wherein the inferential sequence corresponding to the fault is a reversed diagnostic sequence based on one of the one or more diagnostic sequences.

5. The method of claim 1, wherein the symbolic engine includes a system graph component and an application programming interface (API) embedding component.

6. The method of claim 5, wherein the system graph component is configured to:
aggregate system data of the process system associated with at least one of: (i) one or more faults, (ii) one or more components, (iii) one or more sensors, or (iv) one or more residuals; and
instantiate the system graph for evaluation as part of the symbolic engine.

7. The method of claim 5, wherein the API embedding component is configured to:
embed an LLM API associated with the LLM within the symbolic engine; and
manage a context window of the LLM corresponding to the system graph.

8. The method of claim 7, wherein managing the context window of the LLM includes:
analyzing system data of the process system indicated in the system graph to determine relevant system data; and
providing the relevant system data to the LLM.

9. The method of claim 1, wherein each response determined by the LLM includes a human-readable explanation associated with the fault.

10. The method of claim 1, wherein each request received at the one or more processors includes a human-readable portion associated with the fault.

11. The method of claim 1, further comprising:
determining, by the one or more processors, an action to address the fault; and
generating, by the one or more processors, each data object of the one or more data objects to include the action to address the fault.

12. The method of claim 11, further comprising:
transmitting, by the one or more processors, a control instruction to a controller of the process system to perform the action.

13. A computer system for improving fault diagnostics, the computer system comprising:
one or more processors; and
a non-transitory computer-readable medium storing thereon instructions that, when executed by the one or more processors, cause the computer system to:
receive one or more requests associated with a fault within a process system,
apply a large language model (LLM) to the one or more requests, wherein applying the LLM includes:
querying a symbolic engine based on the one or more requests, wherein the symbolic engine constrains responses output by the LLM based on a system graph associated with the process system,
receiving, from the symbolic engine, an inferential sequence corresponding to the fault that is represented within the system graph, and
determining a response to at least one of the one or more requests based on the inferential sequence, and store one or more data objects indicating each of the responses.

14. The computer system of claim 13, wherein the instructions, when executed, further cause the computer system to apply the LLM to the one or more requests by:
determining, by the symbolic engine, the inferential sequence corresponding to the fault based on a diagnostic sequence indicated in the system graph.

15. The computer system of claim 13, wherein the instructions, when executed, further cause the computer system to:
create, by the symbolic engine, the system graph based on one or more diagnostic sequences performed by a diagnostics tool associated with the process system.

16. The computer system of claim 15, wherein the inferential sequence corresponding to the fault is a reversed diagnostic sequence based on one of the one or more diagnostic sequences.

17. The computer system of claim 13, wherein the symbolic engine includes a system graph component and an application programming interface (API) embedding component.

18. The computer system of claim 17, wherein the system graph component is configured to:
aggregate system data of the process system associated with at least one of: (i) one or more faults, (ii) one or more components, (iii) one or more sensors, or (iv) one or more residuals; and
instantiate the system graph for evaluation as part of the symbolic engine.

19. The computer system of claim 17, wherein the API embedding component is configured to:
embed an LLM API associated with the LLM within the symbolic engine; and
manage a context window of the LLM corresponding to the system graph by:
analyzing system data of the process system indicated in the system graph to determine relevant system data, and
providing the relevant system data to the LLM.

20. A non-transitory computer-readable storage medium including instructions that, when executed by one or more processors, cause the one or more processors to:
receive one or more requests associated with a fault within a process system;
apply a large language model (LLM) to the one or more requests, wherein applying the LLM includes:
querying a symbolic engine based on the one or more requests, wherein the symbolic engine constrains responses output by the LLM based on a system graph associated with the process system,
receiving, from the symbolic engine, an inferential sequence corresponding to the fault that is represented within the system graph, and
determining a response to at least one of the one or more requests based on the inferential sequence; and
store one or more data objects indicating each of the responses.
